(19) United States
(12) Patent Application Publication
(10) Pub. No.: US 2017/0334045 A1
(43) Pub. Date: Nov. 23, 2017

(54) Torque Warning Structure of Rotary Hand Tool

(71) Applicant: BIRZMAN CORP., Dacun Township (TW)

(72) Inventor: Chung-Tsun Kuo, Dacun Township (TW)

(21) Appl. No.: 15/159,023

(22) Filed: May 19, 2016

(51) Int. Cl. B25B 23/142; B25B 15/00

(52) U.S. Cl. CPC B25B 23/1427; B25B 15/008

(57) ABSTRACT

An torque warning structure is adapted for a rotary hand tool, and the rotary hand tool contains at least one rotatable pulling bar, one of the at least one rotatable pulling bar includes a fulcrum portion and at least one forcing portion. The torque warning structure contains at least one resilient element which is solely mounted or is jointly stacked on the at least one forcing portion, and each of the at least one resilient element has a pushing portion and a contacting portion between which a height difference is defined, the contacting portion contacts the at least one forcing portion, wherein the pushing portion drives the rotary hand tool to rotate, and when a pushing force of the pushing portion of said each resilient element is more than a deformation resistance of said each resilient element, said each resilient element deforms and makes warning sound.

### BACKGROUND OF THE INVENTION

### Field of the Invention

The present invention relates to a rotary hand tool, and more particularly to a torque warning structure of the rotary hand tool which deforms and makes warning sounds by at least one resilient element.

### Description of the Prior Art

A conventional rotary hand tool rotates a screwing element tightly or loosely based on a lever rule, thus assembling and disassembling related components. It is noted that the screwing element is rotated in different torque forces, for example, when rotating the screwing element in sufficient or insufficient force, the screwing element or the related components cause damage. Therefore, the conventional rotary hand tool controls torque force as rotating the screwing element.

A torque warning structure is applicable for the conventional rotary hand tool, but it is complicated to cause a large size, is assembled inconveniently, is manufactured at high cost, and is stored and portable troublesomely.

The present invention has arisen to mitigate and/or obviate the afore-described disadvantages.

### SUMMARY OF THE INVENTION

The primary objective of the present invention is to provide a torque warning structure of a rotary hand tool which contains at least one forcing portion arranged on one of at least one rotatable pulling bar of the rotary hand tool by using at least one resilient element so as to reduce components, simplify structure, achieve easy assembly, and lower production cost.

Another objective of the present invention is to provide a torque warning structure of a rotary hand tool which contains the at least one forcing portion arranged on the one rotatable pulling bar of the rotary hand tool by using the at least one resilient element so as to decrease a size of the rotary hand tool and to obtain easy storage and carrying purposes.

To obtain above objectives, a torque warning structure provided by the present invention is adapted for a rotary hand tool, and the rotary hand tool contains at least one rotatable pulling bar, one of the at least one rotatable pulling bar includes a fulcrum portion and at least one forcing portion. The torque warning structure contains at least one resilient element which is solely mounted or is jointly stacked on the at least one forcing portion of the one rotatable pulling bar of the rotary hand tool, each of the at least one resilient element has a pushing portion and a contacting portion between which a height difference is defined, and the contacting portion of said each resilient element contacts the at least one forcing portion of the one rotatable pulling bar, wherein the pushing portion drives the rotary hand tool to rotate, and when a pushing force of the pushing portion of said each resilient element is more than a deformation resistance of said each resilient element, said each resilient element deforms and makes warning sound.

### BRIEF DESCRIPTION OF THE DRAWINGS

FIG. 1 is a perspective view showing the assembly of a torque warning structure of a rotary hand tool in accordance with a first embodiment of the present invention.

FIG. 2 is a perspective view showing the exploded components of the torque warning structure of the rotary hand tool in accordance with the first embodiment of the present invention.

FIG. 3 is a cross sectional view taken along the line of A-A of FIG. 1

FIG. 4 is an amplified cross sectional view of a portion A of FIG. 3.

FIG. 5 is a perspective view showing the operation of the torque warning structure of the rotary hand tool in accordance with the first embodiment of the present invention.

FIG. 6 is a cross sectional view showing a resilient element of the torque warning structure of the rotary hand tool deforms in accordance with the first embodiment of the present invention.

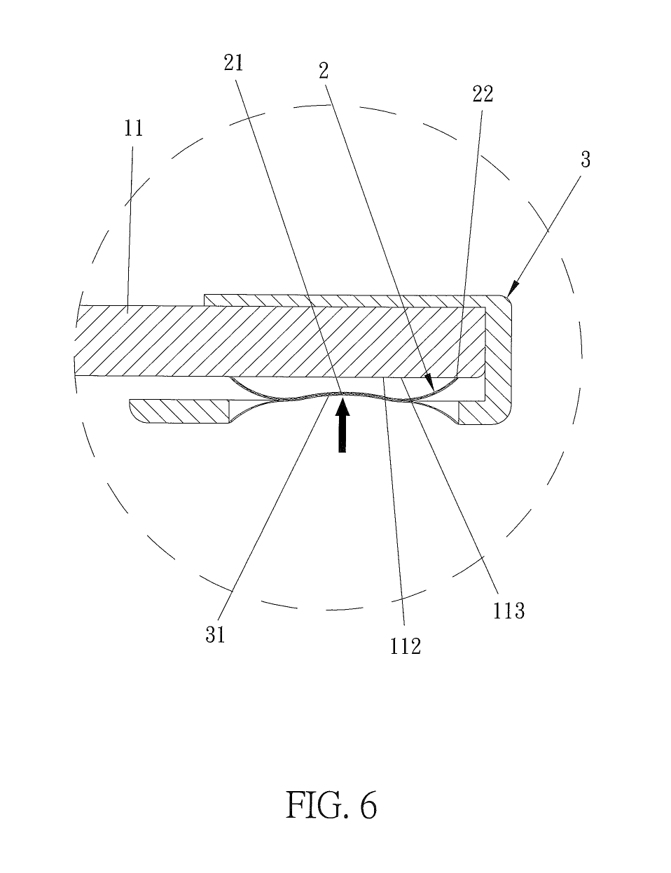

FIG. 7 is a perspective view showing the assembly of a torque warning structure of a rotary hand tool in accordance with a second embodiment of the present invention.

FIG. 8 is a cross sectional view taken along the line of B-B of FIG. 7.

FIG. 9 is an amplified cross sectional view of a portion B of FIG. 8.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

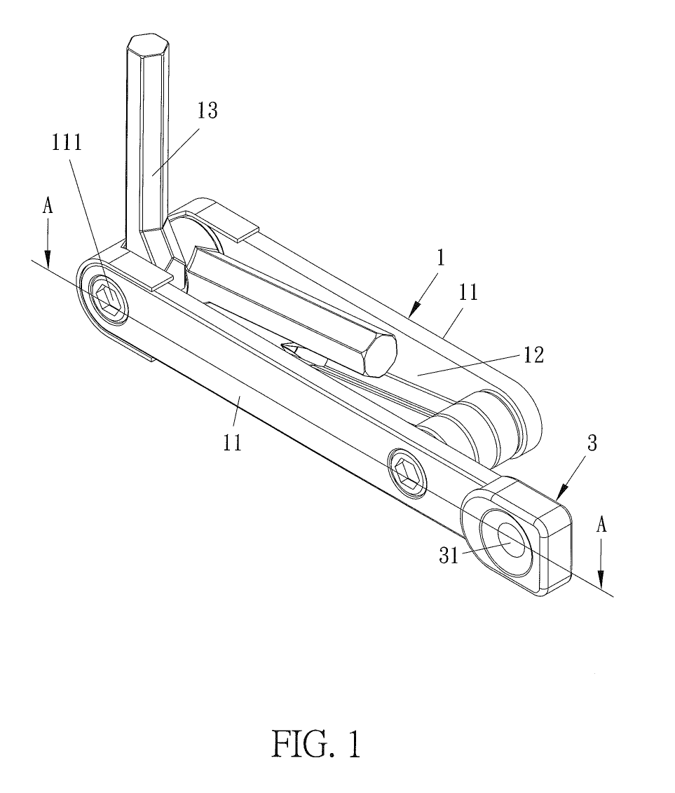

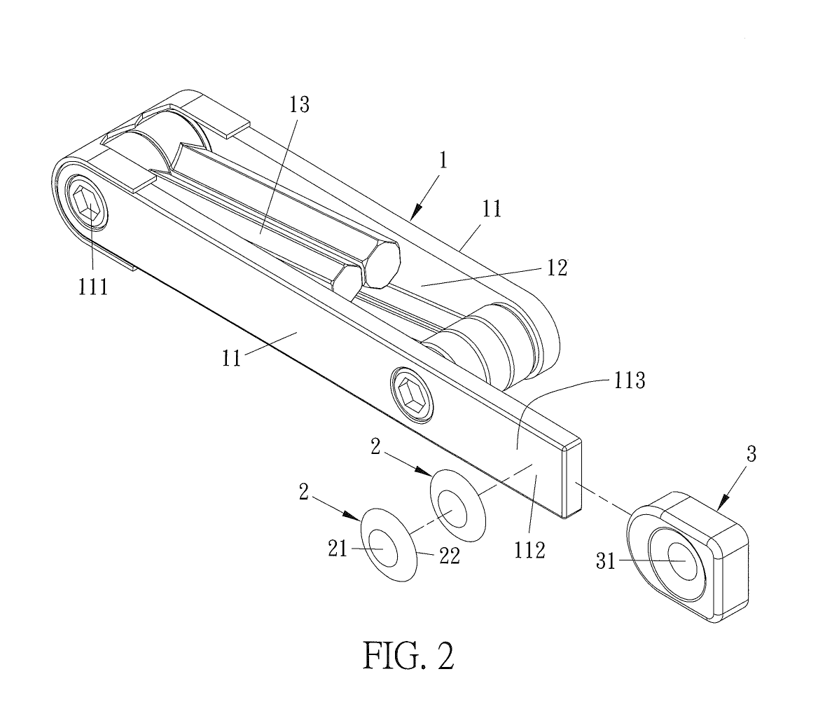

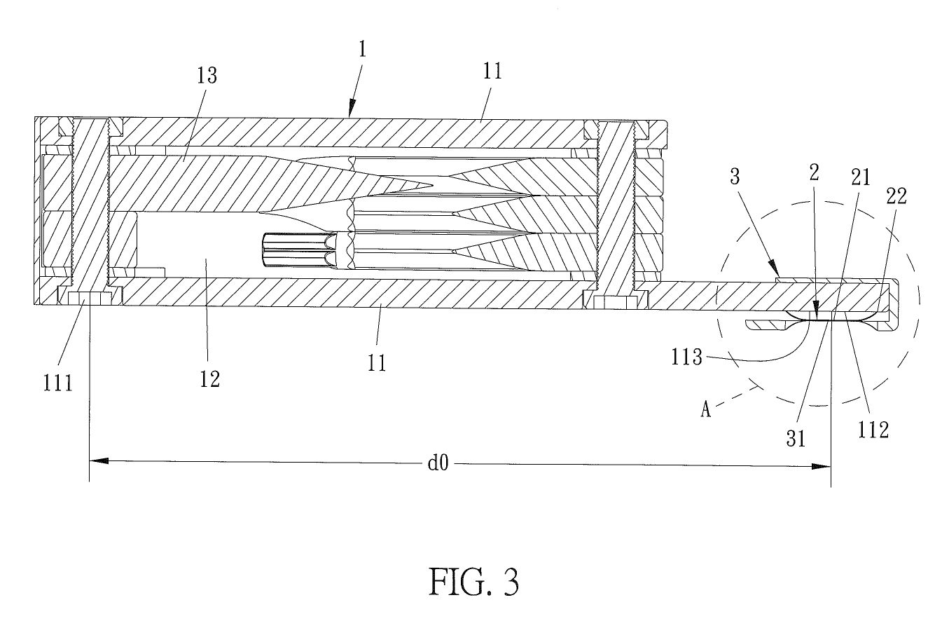

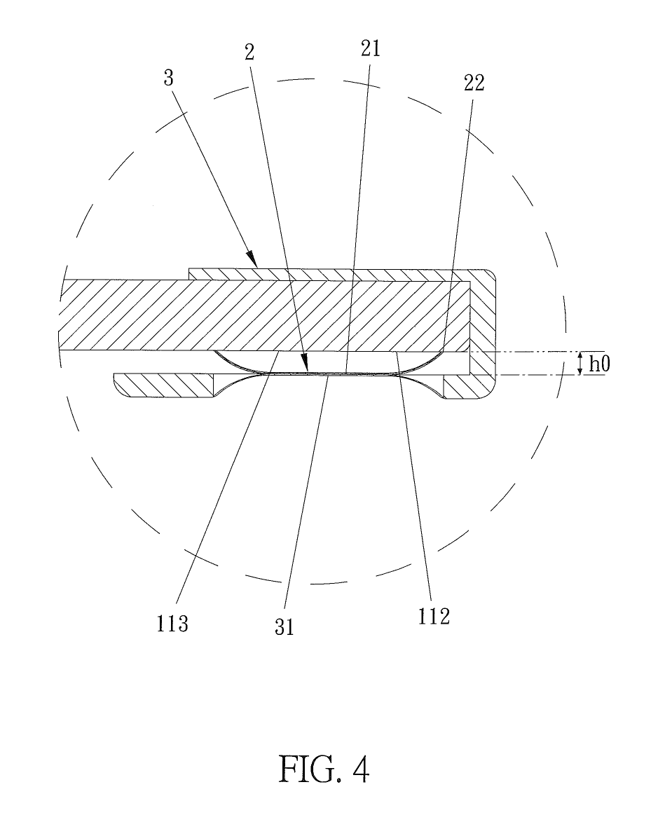

With reference to FIGS. 1 to 4, a torque warning structure according to a first embodiment of the present invention is adapted for a rotary hand tool 1, and the rotary hand tool 1 comprises two rotatable pulling bars 11 parallelly arranged on two sides thereof, respectively, wherein one of the two rotatable pulling bars 11 includes a fulcrum portion 111 and a forcing portion 112 formed on a panel 113, between the fulcrum portion 111 and the forcing portion 112 defines a force arm d0, and between the two rotatable pulling bars 11 forms an accommodation space 12 in which a plurality of tool stems 13 are rotatably connected. The torque warning structure comprises at least one resilient element 2 and a protective sleeve 3, and the at least one resilient element 2 is in a circular disc shape and is solely mounted or jointly stacked on the forcing portion 112 of the one rotatable pulling bar 11 of the rotary hand tool 1. In this embodiment, two resilient elements 2 are jointly stacked on the forcing portion 112 of the one rotatable pulling bar 11 of the rotary hand tool 1. Each of the two resilient elements 2 has a pushing portion 21 and a contacting portion 22 between which a height difference h0 is defined, and the contacting portion 22 of said each resilient element 2 contacts the forcing portion 112 of the one rotatable pulling bar 11. The protective sleeve 3 is made of flexible material (such as rubber or silicone) and is fitted on the forcing portion 112 of the one rotatable pulling bar 11 and covers the at least one resilient element 2, wherein the protective sleeve 3 has an abutting portion 31 defined on one side surface thereof and contacting with the pushing portion 21 of said each resilient element 2.

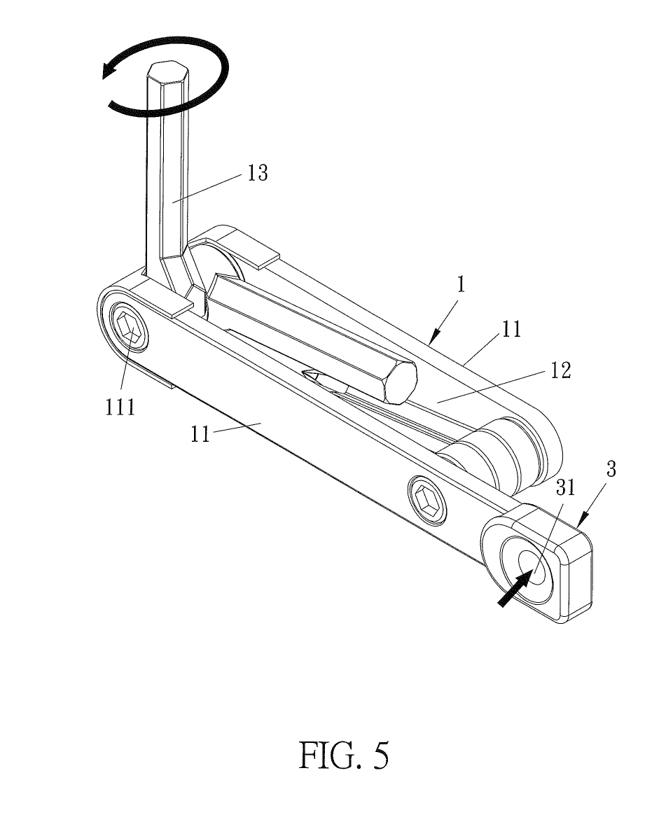

Referring to FIG. 5, in operation, one of the plurality of tool stems 13 of the rotary hand tool 1 is rotated to be perpendicular to the two rotatable pulling bars 11 and to fit with a screwing element (not shown), wherein the abutting portion 31 of the protective sleeve 3 pushes the pushing portion 21 of said each resilient element 2, and the pushing portion 21 drives the rotary hand tool 1 to rotate, thus rotating the screwing element tightly or loosely. When the screwing element is rotated to a predetermined tightness, and a pushing force of the pushing portion 21 of said each resilient element 2 is more than a deformation resistance of said each resilient element 2, the height difference h0 between the pushing portion 21 and the contacting portion 22 of said each resilient element 2 deforms and makes warning sounds so that user does not exert excessive torque force, thus avoiding damage of the screwing element.

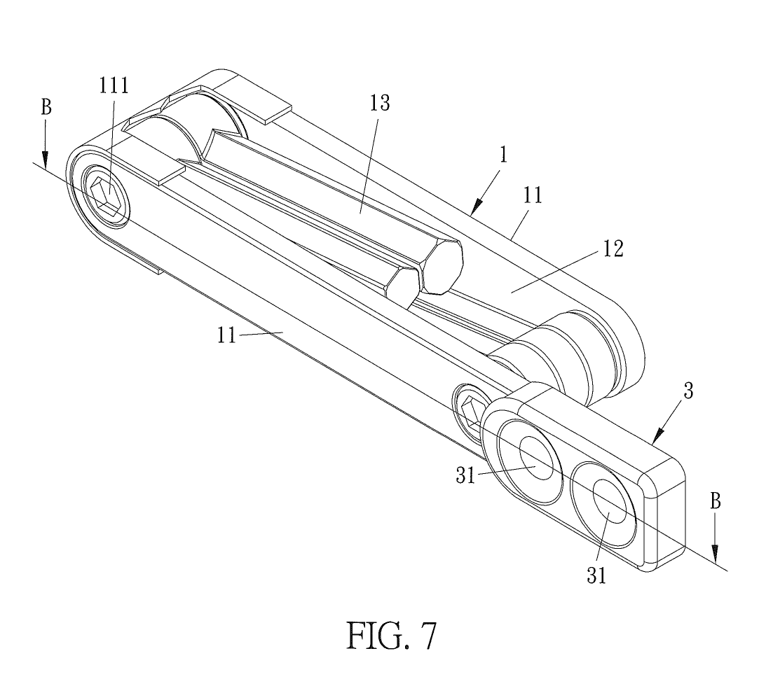

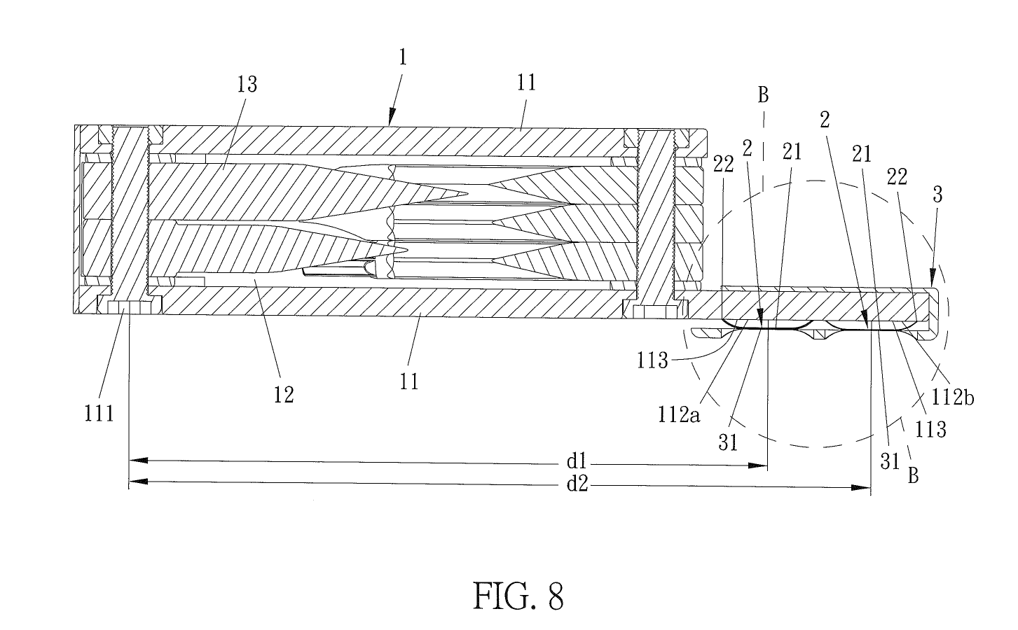

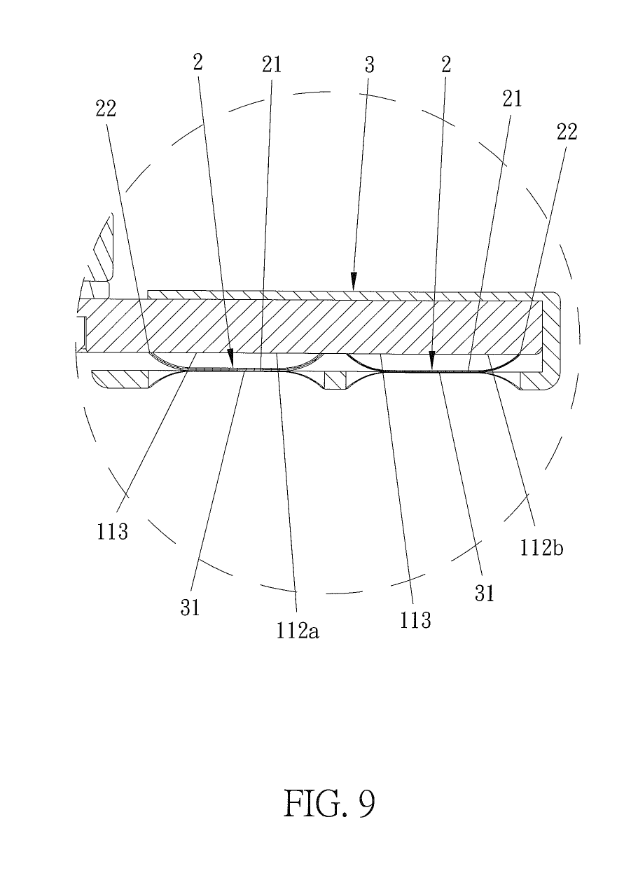

As illustrated in FIGS. 7 to 9, in a second embodiment, one of the two rotatable pulling bars 11 includes a fulcrum portion 111, and the one rotatable pulling bar 11 also includes a first forcing portion 112a and a second forcing portion 112b which are formed on a panel 113, wherein between the fulcrum portion 111 and the first forcing portion 112a forms a first force arm d1, and between the fulcrum portion 111 and the second forcing portion 112b forms a second force arm d2, wherein the first force arm d1 is less than the second force arm d2, at least one resilient element 2 is solely mounted or is jointly stacked on the first forcing portion 112a and the second forcing portion 112b of the one rotatable pulling bar 11 of the rotary hand tool 1. The protective sleeve 3 is fitted on the first forcing portion 112a and the second forcing portion 112b of the one rotatable pulling bar 11 and covers the at least one resilient element 2, wherein the protective sleeve 3 has two abutting portions 31 defined on one side surface thereof and contacting with the first forcing portion 112a and the second forcing portion 112b of the pushing portion 21 of said each resilient element 2.

Thereby, the two abutting portions 31 of the protective sleeve 3 push the first forcing portion 112a or the second forcing portion 112b of the pushing portion 21 of said each resilient element 2 so as to rotate the screwing element tightly or loosely by way of a length difference between the first force arm d1 and the second force arm d2, hence the at least one resilient element 2 deforms and makes warning sounds in different torques, and the torque warning structure obtains two-section torque warning function.

Preferably, the one rotatable pulling bar 11 of the rotary hand tool 1 has three forcing portions or more than three forcing portions so as to obtain multi-section torque warning functions.

Accordingly, the torque warning structure of the present invention has advantages as follows:

1. The torque warning structure of the rotary hand tool comprises the forcing portion 112, the first forcing portion 112a, and the second forcing portion 112b of the one rotatable pulling bar 11 of the rotary hand tool 1 which are arranged by using the at least one resilient element 2, thus reducing components, simplifying structure, achieving easy assembly, and lowering production cost.

2. The torque warning structure of the rotary hand tool comprises the forcing portion 112, the first forcing portion 112a, and the second forcing portion 112b of the one rotatable pulling bar 11 of the rotary hand tool 1 which are arranged by using the at least one resilient element 2, thus decreasing a size of the rotary hand tool 1 and obtaining easy storage and carrying purposes.

While we have shown and described various embodiments in accordance with the present invention, it is clear to those skilled in the art that further embodiments may be made without departing from the scope of the present invention.

What is claimed is:

1. An torque warning structure being adapted for a rotary hand tool, and the rotary hand tool comprising at least one rotatable pulling bar, one of the at least one rotatable pulling bar including a fulcrum portion and at least one forcing portion, the torque warning structure comprising at least one resilient element which is solely mounted or is jointly stacked on the at least one forcing portion of the one rotatable pulling bar of the rotary hand tool, each of the at least one resilient element having a pushing portion and a contacting portion between which a height difference is defined, and the contacting portion of said each resilient element contacting the at least one forcing portion of the one rotatable pulling bar, wherein the pushing portion drives the rotary hand tool to rotate, and when a pushing force of the pushing portion of said each resilient element is more than a deformation resistance of said each resilient element, said each resilient element deforms and makes warning sound.

2. The torque warning structure as claimed in claim 1, wherein between the fulcrum portion and the at least one forcing portion defines at least one force arm.

3. The torque warning structure as claimed in claim 1, wherein the at least one resilient element is in a circular disc shape.

4. The torque warning structure as claimed in claim 1 further comprising a protective sleeve fitted on the at least one forcing portion of the one rotatable pulling bar and covering the at least one resilient element, wherein the protective sleeve has an abutting portion defined on one side surface thereof and contacting with the pushing portion of said each resilient element.
